(19) United States
(12) Patent Application Publication
(10) Pub. No.: US 2009/0094567 A1
(43) Pub. Date: Apr. 9, 2009

(54) IMMUNITY TO CHARGING DAMAGE IN SILICON-ON-INSULATOR DEVICES

(76) Inventors: Chung-Ping Eng, Hopewell Junction, NY (US); Terence B. Hook, Jericho, VT (US); Jeffrey S. Zimmerman, Swanton, VT (US)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/869,176

(22) Filed: Oct. 9, 2007

(51) Int. Cl. G06F 17/50

(52) U.S. Cl. 716/4

(57) ABSTRACT

Method embodiments herein determine a connection order in which connections will be made to connect active devices to antennas within a given circuit design. The method also evaluates the possibilities that these connections to the antennas will cause charging damage in the devices that are connected to the antennas. Such possibilities are based on the connection order, the size of the antennas, and the likelihood that charges will flow from the antennas through insulators of the devices. If a significant possibility for damage exists, the method can reduce the size of the antenna.

### BACKGROUND AND SUMMARY

The embodiments of the invention generally relate to a method of avoiding charging damage in a silicon-on-insulator circuit design by limiting antenna sizes.

During the manufacturing of integrated circuit devices, such as silicon-on-insulator devices, charging damage can occur. This charging damage can be caused when two regions of the design charge up to different potentials during manufacturing. Once different devices charge to different potentials, the discharge of such potential (or equalization) should occur through a conductive path and should not pass through insulators (such as a gate oxide) or the result could be transistor damage.

Method embodiments herein determine a connection order in which connections will be made to connect active devices to antennas within a given circuit design. This connection order can be determined simply by seeing the order in which different metallization levels are formed. In addition, the circuit layout as well as the detailed steps of deposition, patterning, polishing, etc. within the process of forming a single metallization layer are evaluated to determine which connections are truly simultaneous and which connections can occur before others.

The method also evaluates the possibilities that these connections to the antennas will cause charging damage in the devices that are connected to the antennas. Such possibilities are based on the connection order, the size of the antennas, and the likelihood that charges will flow from the antennas through insulators of the devices. If a significant possibility for damage exists, the method can alter the connection order or reduce the size of the antennas (for those possibilities that exceed a predetermined standard).

When evaluating the possibilities, the process evaluates the connections to antennas individually, in the connection order. Therefore, for any connections that are not actually simultaneously formed, as each connection is formed in the connection order, the devices that are connected to antennas are evaluated to determine if such connections would cause destruction of insulators within transistors of such devices, with the assumption that no subsequent connections are yet formed. Again, if the possibility of damage is high enough, the connection order can be changed or the size of the antenna can be reduced to avoid such charging damage.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of a structure having antennas; and

FIG. 2 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, during the manufacturing of integrated circuit devices, such as silicon-on-insulator devices, charging damage can occur. The discharge of such charges should occur through a conductive path and should not pass through insulators (such as a gate oxide) or the result could be transistor damage. The present embodiments note that simultaneous formation of interconnections is useful in preventing charging damage. Further, whether connections are formed simultaneously can be determined from an examination of the circuit layout. Alternate solutions to the problem of charge accumulation during manufacturing use higher level of metalizations for the susceptible interconnect, which may be very expensive.

In order to avoid increasing the cost of manufacturing, the invention examines the layout and determines the order that the interconnections (even those on the same level) will form. By determining a connection order, devices that are potentially exposed to damage can be identified, and the layout altered. No additional levels of wiring need be employed in this method.

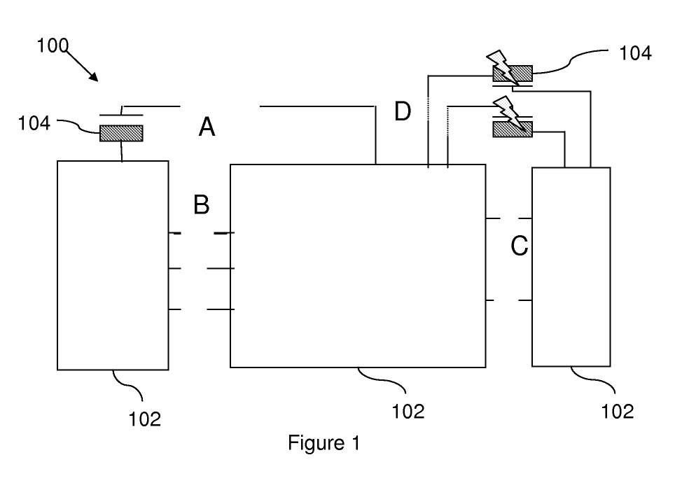

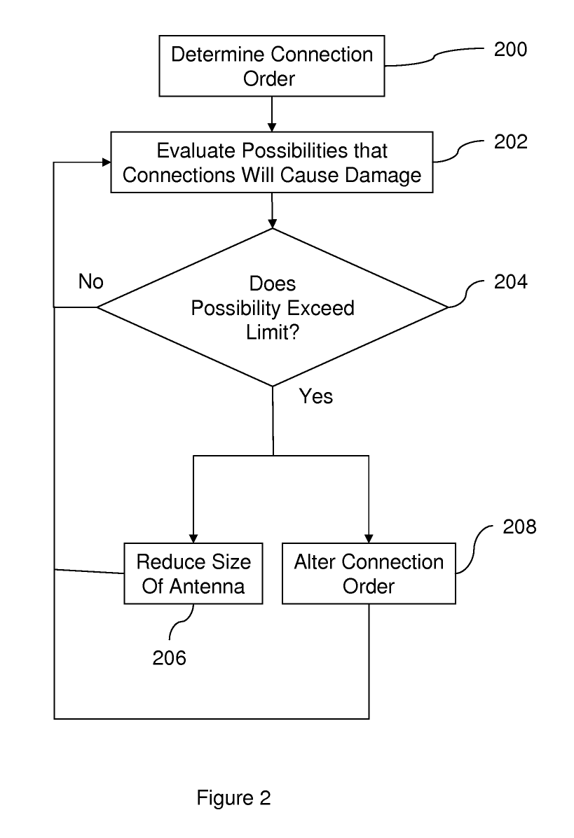

More specifically, as shown in FIGS. 1 and 2, method embodiments herein determine a connection order (200) in which connections A, B, C, D will be made to connect active devices 104 to antennas 102 within a given circuit design 100. This connection order can be determined simply by seeing which levels of different metallization levels are formed before other levels.

In addition, the circuit layout as well as the detailed steps of deposition, patterning, polishing, etc. within the process of forming a single metallization layer can be evaluated to determine which connections are truly simultaneous and which connections can occur before others (even those on the same metallization level). For example, in FIG. 1, connection path D can form before connection paths C or B, because connection path D could be much shorter than path C or path D. Connection A may be formed much later because, for example, Connection A could be at a higher level of metallization.

The method also evaluates the possibilities that these connections to the antennas will cause charging damage in the devices that are connected to the antennas (202). Such possibilities are based on the connection order, the size of the antennas, and the likelihood that charges will flow from the antennas through insulators of the devices. If a significant possibility for damage exists (204), the method can alter the connection order (208) or reduce the size of the antennas 206 (for those possibilities that exceed a predetermined standard). If the possibility does not exist, the next connections that are formed can be evaluated, as shown in the arrow between items 204 and 202 in FIG. 2.

When evaluating the possibilities in item 202, the process evaluates the connections to antennas individually, in the connection order. Therefore, for any connections that are not actually simultaneously formed, as each connection is formed in the connection order, the devices that are connected to antennas are evaluated to determine if such connections would cause destruction of insulators within transistors of such devices, with the assumption that no subsequent connections are yet formed. Again, if the possibility of damage is high enough, the connection order can be altered or the size of the antenna can be reduced to avoid such charging damage.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method of avoiding charging damage in a silicon-on-insulator circuit design, said method comprising:
determining a connection order in which connections will be made to antennas within said circuit design;
evaluating possibilities that connections to said antennas will cause charging damage in devices connected to said antennas, based on said connection order; and
one of altering said connection order and reducing a size of said antennas for ones of said possibilities that exceed a predetermined standard.

2. The method according to claim 1, all the limitations of which are incorporated herein by reference, wherein said evaluating of said possibilities comprising evaluating said connections to antennas individually, in said connection order.

3. The method according to claim 1, all the limitations of which are incorporated herein by reference, wherein said damage comprises destruction of insulators within transistors.

4. A method of avoiding charging damage in a silicon-on-insulator circuit design, said method comprising:
determining a connection order in which connections will be made to antennas within said circuit design;
evaluating possibilities that connections to said antennas will cause charging damage in devices connected to said antennas, based on said connection order, a size of said antennas and a likelihood that charges will flow from said antennas through insulators of said devices; and
same reducing a size of said antennas for ones of said possibilities that exceed a predetermined standard.

5. The method according to claim 4, all the limitations of which are incorporated herein by reference, wherein said evaluating of said possibilities comprising evaluating said connections to antennas individually, in said connection order.

6. The method according to claim 4, all the limitations of which are incorporated herein by reference, wherein said damage comprises destruction of insulators within transistors.
